(19) United States
(12) Patent Application Publication
(10) Pub. No.: US 2022/0220994 A1
(43) Pub. Date: Jul. 14, 2022

(54) CONNECTING ELEMENT HAVING A THREADED CONNECTING PART

(71) Applicant: Schaeffler Technologies AG & Co. KG, Herzogenaurach (DE)

(72) Inventors: Andreas Kaiser, Werneck (DE); Alois Friedrich, Dinkelsbühl (DE)

(73) Assignee: Schaeffler Technologies AG & Co. KG, Herzogenaurach (DE)

(21) Appl. No.: 17/609,821

(22) PCT Filed: Jun. 2, 2020
(86) PCT No.: PCT/DE2020/100457

§ 371 Date: Nov. 9, 2021

(30) Foreign Application Priority Data
Jun. 4, 2019 (DE) 10 2019 003 858.4

(51) Int. Cl. F16B 31/06

(52) U.S. Cl. CPC F16B 31/06

(57) ABSTRACT

A connecting element (1, 11) has a connecting part (2, 12) which has a thread (3, 13),
wherein the thread (3-13) comprises a nominal diameter (d),
a flank diameter (d₂),
a pitch (S_{ges}),
and —thread turns (n_{ges}),
wherein the pitch (S_{ges}) of the thread (3, 13) is made up of a first pitch (Sₙₒᵣₘ) and of a second pitch (S_{diff}),
wherein the first pitch is a standard pitch (Sₙₒᵣₘ), in particular corresponding to the nominal diameter (d), and
wherein the second pitch (S_{diff}) corresponds to an amount of elastic and/or plastic extension under strain (f, fz) of the threaded connecting part (2, 12),
wherein the extension under strain (f, fz) occurs in a predetermined operating state of the threaded connecting element (1, 11).

### CROSS-REFERENCE TO RELATED APPLICATIONS

This application is the U.S. National Phase of PCT Appln. No. PCT/DE2020/100457 filed Jun. 2, 2020, which claims priority to DE 10 2019 003 858.4 filed Jun. 4, 2019 and DE 10 2019 122 279.6 filed Aug. 20, 2019, the entire disclosures of which are incorporated by reference herein.

### TECHNICAL FIELD

The disclosure relates to a connecting element having a threaded connecting part, a screw connection for the connection of components, and a method for producing a thread of a connecting part of a connecting element.

### BACKGROUND

The electrification of vehicles increases vehicle weights and thereby the loads on the wheel bolts between, for example, an internally threaded wheel flange and a bolt, each of which is fitted with standardized threads.

With these standardized threads, the used screws usually crack in the second thread turn because according to the standard design, the stresses at the notch root are greatest here.

### SUMMARY

It is desirable to provide a connecting element with a threaded connecting part, a screw connection for connecting two components and a method for producing a thread, which can be implemented in a cost-effective and material-saving manner and ensures an improved distribution of force and stress along the thread, so that screw cracks can be avoided.

A connecting element includes a connecting part.

The connecting element may have a thread, wherein the thread has a nominal diameter (d), a flank diameter (d₂), a pitch (S_{ges}), and a number of thread turns (n_{ges}).

Furthermore, it is preferred that the pitch (S_{ges}) of the thread is made up of a first pitch (Sₙₒᵣₘ) and a second pitch (S_{diff}).

The first pitch (Sₙₒᵣₘ) is favorably a standard pitch, in particular corresponding to the nominal diameter. In addition, the flank diameter (d₂) and the pitch (S_{ges}) are preferably derived from a corresponding screw standard corresponding to the nominal diameter (d).

It is also advantageous if the second pitch (S_{diff}) corresponds to an amount of elastic and/or plastic extension under strain (f, f_{Z}) of the threaded connecting part.

Preferably, the extension under strain occurs in a predetermined operating state of the threaded connecting element.

In particular, the inclusion of the extension under strain in a predetermined operating state of the threaded connecting element causes a reduction of the stresses at the notch root of the second thread turn while maintaining the tension force of a threaded or screw connection, respectively.

Thus, preferably, when the extension under strain is accounted for in the pitch of a thread in a predetermined operating state of the threaded connecting element, stresses are distributed over multiple thread turns.

Also, by accounting for the extension under strain in a predetermined operating state of the connecting element having a thread in the pitch of a thread, the fatigue strength of the connecting element, e.g., in the embodiment of a screw, can be improved in an overelastic tightening process (yield strength controlled tightening process).

Briefly summarized, extension of the threaded connecting part can be compensated for, for example, in the form of screw elongation or in the form of extension under strain as a result of assembly pretensioning and tension/compression load in a predetermined operating state of the threaded connecting element.

It should be noted that in the present description, elastic and/or plastic extension under strain can be negative in nature as well as positive. This means that the extension under strain can lead to a threaded connecting part, for example, being drawn out to a greater length under load or in the operating state than before or in the unloaded state. Or the extension under strain can preferably result in a threaded connecting part, for example, being compressed, i.e., having a shorter length under load or in the operating state than before or in the unloaded state. An extension under strain of a negative nature can also be referred to as a compression.

Advantageously, the elastic and/or plastic extension under strain, in particular due to the action of the axially extending, acting force, runs in the direction in which the thread extends. In other words, it is advantageous for the elastic and/or plastic extension under strain to extend in the direction along which the pitch of a thread is known to be detected.

It is also advantageous if, in the predetermined operating state, the threaded connecting part is designed for an acting force (F). Firstly, the operating state (static or dynamic [threshold dynamic or alternating dynamic]) is usually determined before using a connecting element with a threaded connecting part. Secondly, depending on the predetermined operating state, the operating force acting on the connecting element is normally determined by calculation. Thus, it is possible to calculate whether or not the connecting element will hold up under the influence of the expected operating force in the predetermined operating state. This calculation preferably also determines whether the connecting element extends or elongates by a distance, the extension under strain, due to the operating force acting in the predetermined operating state. In this regard, according to Hooke's law, at least in the linear-elastic range, the extension under strain depends on the acting operating force. In other words, the extension under strain in an operating state in which an operating force of, for example, 15 kN acts on a screw is less than the extension under strain in an operating state in which an operating force of, for example, 30 kN acts on the screw.

Preferably, the acting force (F) comprises an operating force (F_{B}), which preferably acts on the connecting element as an external tensile and/or compressive force.

Furthermore, it is possible for the acting force (F) to comprise an assembly pretensioning force (F_{M}), with which the connecting element preferably rests against a component in a fastening manner, in particular via an intermediate part.

Furthermore, it can be provided for that the acting force (F) comprises the operating force (F_{B}) and the assembly pretensioning force (F_{M}), which is preferably expressed in an equation as follows:

$$F = {F}_{B} + {F}_{M}$$

Preferably, the second pitch (S_{diff}) decreases or increases the first pitch (Sₙₒᵣₘ), in particular the standard pitch (Sₙₒᵣₘ), of the thread. This is preferably expressed in an equation as follows:

$${S}_{g e s} = {S}_{norm} - {S}_{diff}$$

$$or$$

$${S}_{g e s} = {S}_{norm} + {S}_{diff}$$

For example, for a thread with the nominal diameter of 8 mm or for an M8 thread, the first pitch (Sₙₒᵣₘ) equals 1.5 mm; this 1.5 mm is then preferably changed by (S_{doff}). It is also preferred that the first pitch (Sₙₒᵣₘ), in particular the standard pitch (Sₙₒᵣₘ), corresponding to the nominal diameter comprises a metric standard, in particular a metric thread, or an inch standard, in particular an inch thread.

Furthermore, it can be provided for that the connecting element with the threaded connecting part is a component with an external thread, in particular a screw.

Alternatively, it can be provided for that the connecting element with the threaded connecting part is a component with an internal thread, in particular a nut. Preferably, the connecting element is a wheel flange.

Advantageously, the second pitch comprises a quotient having a dividend and a divisor.

Here it is advantageous if the dividend comprises the elastic and/or plastic extension under strain (f) of the threaded connecting part at the force (F) acting in the operating state and the divisor comprises all the thread turns (n_{ges}) of the thread or at least part of the thread turns (nₜₑᵢₗ) of the thread. Consequently and preferably as described above, the elastic and/or plastic extension under strain (f) is dependent on the force (F) acting in the operating state. This therefore preferably results in the following equation:

$${S}_{diff} = f ( F ) / {n}_{g e s}$$

$$or$$

$${S}_{diff} = f ( F ) / {n}_{teil}$$

As already mentioned, it is favorable if the force acting in the operating state is equal to the assembly pretensioning force (F_{M}) and/or the operating force (F_{B}), which can preferably act on the connecting element with a tensile and/or compressive force.

Furthermore, it is advantageous if the part of the thread turns (nₜₑᵢₗ) of the thread is the number of thread turns screwed in during the operating state. Preferably, the thread turns screwed in during the operating state are those thread turns that at least potentially interact with a mating thread, such as when a screw is screwed into a nut. Also, it is preferably the number of thread turns that are potentially capable of transmitting forces because they are screwed into or engage a mating thread.

Thus, it is preferred that the number of thread turns screwed in during the operating state corresponds with the screw-in length (lₑ) or with the length of the threaded part screwed in during the operating state, with which the connecting part is screwed in a mating thread. This means that, preferably, for example, in the case of a screw connection of a screw with an internal thread, all thread turns (n_{ges}) of the internal thread and thus the length (lₑ) of the entire internal thread transmit forces. On the other hand, in the case of a screw, the part of the thread turns (nₜₑᵢₗ) which is screwed into the internal thread or is in engagement with it in the operating state preferably transmits forces, and accordingly only the length (lₑ) of the screw thread which is screwed in during the operating state.

Advantageously, the second pitch (S_{diff}) is variable by a factor (P) in a range between 100% and 550% or between 1 and 5.5. This is preferably expressed in an equation as follows:

S_{diff}*P; where P is variable between 1(100%) and 5.5(550%).

In summary, it is therefore advantageous that the pitch (S_{ges}) of the thread is made up of a first pitch (Sₙₒᵣₘ) and a second pitch (S_{diff}) with the factor (P). This is preferably expressed in an equation as follows:

$${S}_{g e s} = {S}_{norm} + P * {S}_{diff}$$

Also, it is favorable if at the factor (P) of 100%, all the threads turns (n_{ges}) screwed in during the operating state transmit forces.

Preferably, at a factor (P) of 550%, at least the three threads furthest away from the start of the thread in the operating state transmit forces.

As a result, the connecting element or its threaded connecting part modified according to the extension under strain behaves contrary to a connecting part with a standard thread. This is because in the case of standard threads, almost exclusively the first three thread turns (counted from the start of the thread at which the screw connection is started) transmit forces. In contrast, in the case of the connecting element with a modified thread, either all the thread turns (n_{ges}) screwed in during the operating state transmit forces (this is preferably the case at P=100%) or at least the three thread turns furthest away from the start of the thread in the operating state (counted from the start of the thread at the screw connection is started) (this is preferably the case at P=550%). Favorably, in the case of P=550%, the increased extension length of a screw connection improves the fatigue life of this screw connection.

The factor (P) 100% to max. 550% preferably takes into account the displacement over the screw-in length (lₑ) in the core diameter of the screw or the internal thread according to standard tightening procedures up to the area with plastic deformation and preferably after the acting operating force.

Preferably, the second pitch (S_{diff}), in particular the elastic and/or plastic extension under strain (f), comprises a product composed of the displacement (δ) of the thread core and the force (F) acting in the operating state. This is preferably expressed in an equation as follows:

$${S}_{diff} or f ( F ) = δ * F$$

It is further preferred that the displacement (δ) of the thread core comprises a quotient having a dividend and a divisor.

Preferably, the dividend comprises the length (lₑ) of the threaded part screwed in during the operating state, with which the connecting part can be screwed in or is screwed into a mating thread. The usual calculation or design of a connecting part or even a screw connection runs contrary to this. In the usual design or the design known from the background of the art, the so-called equivalent extension length or equivalent length is used as the length, which is conventionally calculated from the product of the number 0.4 and the nominal diameter (d) for an external thread or from the product of the number 0.5 and the nominal diameter (d) for an external thread. This equivalent extension length or equivalent length is replaced in the connecting element disclosed herein by the length (lₑ) of the threaded part screwed in during the operating state.

Furthermore, it can be provided that the divisor comprises a product of the elastic modulus (E) of the material of the connecting element and the cross-section (A) of the thread.

It is advantageous here if the cross-section of the thread corresponds to the core cross-section (A₃) for an external thread or the nominal cross-section (A_{N}) for an internal thread.

This is preferably expressed in an equation as follows under consideration of the aforementioned features:

δ=lₑ/(E*A₃) for an external thread or δ=lₑ/(E*A_{N}) for an internal thread

Advantageously, the distance (x) between two tooth flanks of two adjacent teeth of the thread along the flank diameter (d₂) or the distance (y) between two tooth flanks of a thread tooth of the thread along the flank diameter (d₂) is changed by an amount (z). In this way, the pitch of a thread of a connecting part of a connecting element remains unchanged, but this changes the distance between the individual thread teeth as well as their thickness along the flank diameter.

Preferably, the distance (x) and/or the distance (y) corresponds to the corresponding distance resulting from the first pitch (Sₙₒᵣₘ) or from the first thread, in particular corresponding to the nominal diameter (d).

Furthermore, it is advantageous if the distance (x), which preferably results from the first pitch (Sₙₒᵣₘ), between two opposing tooth flanks of two adjacent teeth is increased along the flank diameter (d₂) by the amount (z).

Alternatively or in addition to this, it is advantageous if the distance (y), which preferably results from the first pitch (Sₙₒᵣₘ), between two tooth flanks of a thread tooth of the thread is decreased by the amount (z) along the flank diameter (d₂).

Regarding both of the above alternatives, it is favorable if the distance (x) is increased by the amount (z) for an internal thread and/or the distance (y) is decreased by the amount (z) for an external thread. Expressed in other words, by changing the distance between two tooth flanks of two adjacent teeth of the thread, the distance between the thread teeth is increased and at the same time their thickness is decreased along the flank diameter, so that the teeth of the thread are narrowed along the flank diameter.

Furthermore, it is preferably provided that the amount (z), by which preferably the distance (x or y) is changed, corresponds at least twice to the second pitch (S_{diff}).

Preferably, the amount (z) by which the distance (x or y) is preferably changed corresponds to the product of the second pitch (S_{diff}) and the sum of all the thread turns (n_{ges}) of the thread and 1, or the product of the second pitch (S_{diff}) and the sum of at least a part of the thread turns (nₜₑᵢₗ) of the thread and 1, wherein preferably the part of the thread turns (nₜₑᵢₗ) of the thread is the number of threads screwed in during the operating state. In particular, if the amount corresponds to the aforementioned product, screwing the threaded connecting part into a mating thread, especially over the length (lₑ) of the threaded part screwed in during the operating state, with which the connecting part is screwed or can be screwed into a mating thread, can be easily performed. Also, with this embodiment, it can be ensured that the thread turns furthest away from the start of the thread transmit forces and not the thread turns located at the start of the thread, as is usual with a standard thread or as is usual with a standard connecting element, such as a screw.

Above context is preferably expressed in an equation as follows:

$$z = {D}_{diff} * ( {n}_{ges or teil} + 1 ) = {S}_{diff} * {n}_{ges or teil} + {S}_{diff}$$

In other words, each distance (x) between two opposing tooth flanks of two adjacent teeth along the flank diameter resulting from the first pitch (Sₙₒᵣₘ) is thus increased by the amount (z), which increases the clearance or distance (x) between the teeth.

Or in other words, if the width of each tooth of a thread is changed or reduced by the amount (y), the thread teeth along the flank diameter become narrower and the clearance (x) between the teeth is increased.

Regardless of whether the distance (x) or the distance (y) is considered, the tooth flank angle of the thread preferably remains unchanged and preferably corresponds to the tooth flank angle of the first pitch (Sₙₒᵣₘ).

Advantageously, the second pitch (S_{diff}) comprises an elastic and/or plastic extension under strain or compression of the tooth flanks of the threaded part screwed in during the operating state, on which the force acting in the operating state acts, so that the screwed-in threaded part has a modified length, in particular an increased or shortened length, compared to the unloaded state. In other words, the threaded connecting part of the connecting element also elongates due to the deformation of the threaded teeth or their tooth flanks or the connecting part does not elongate due to the extension under strain of the tooth flanks, because the tooth flanks compensate for the extension by deformation.

Furthermore, it is advantageous if the second pitch (S_{diff}) has a quotient that has a dividend and a divisor.

Preferably, the dividend comprises the elastic and/or plastic extension under strain or compression (f_{Z}) of the tooth flanks of the threaded part screwed in during the operating state when a force (F) is acting on the connecting part. In other words, the extension under strain/compression depends on the one hand on the operating state and on the other hand on the acting force.

Furthermore, it can be provided that the divisor comprises all thread turns (n_{ges}) of the thread or a part of the thread turns (nₜₑᵢₗ), wherein preferably the part of the thread turns (nₜₑᵢₗ) is the number of thread turns screwed in during the operating state. This is preferably expressed in an equation as follows:

$${S}_{diff} = {f}_{Z} ( F ) / {n}_{g e s}$$

$$or$$

$${S}_{diff} = {f}_{Z} ( F ) / {n}_{teil}$$

Further deformations and changes in the elastic and/or plastic extension under strain or compression (f_{Z}) of the tooth flanks can be derived, for example, using a finite element calculation or method (FEM) for an operating state in each individual case.

Preferably, the number of all thread turns (n_{ges}) of the thread or the number of thread turns screwed in during the operating state, which corresponds to at least part of the thread turns (nₜₑᵢₗ) of the thread, is reduced by a factor of 1 if the connecting element has an internal thread as the threaded connecting part.

This means, preferably:

$${n}_{ges , internal thread} = {n}_{ges} - 1$$

$$or$$

$${n}_{teil , internal thread} = {n}_{teil} - 1$$

A second aspect comprises a screw connection for the connection of components.

It is expressly noted that the features of the connecting element as mentioned in the first aspect may find application in the screw connection, both individually or in combination with one another.

In other words, the features relating to the connecting element mentioned above under the first aspect may also be combined with further features described herein under the second aspect.

Preferably, a screw connection comprises the following for connecting components:

a first connecting element, in particular according to the first aspect, and

a second connecting element, in particular also according to the first aspect.

Advantageously, the first connecting element comprises a first thread and the second connecting element comprises a second thread.

In this context, it is preferred if the first connecting element has an internal thread as the first thread and the second connecting element has an external thread as the second thread.

Alternatively, it is preferred that the first connecting element comprises an external thread as the first thread and the second connecting element comprises an internal thread as the second thread.

In other words, it is preferred that the following combinations of connecting elements are possible:

a) a first connecting element, in particular its first thread, according to the first aspect, and a second connecting element, in particular its second thread, having only a standard thread; or

b) a first connecting element, in particular its first thread, having only a standard thread, and a second connecting element, in particular its second thread, according to the first aspect; or

c) a first connecting element, in particular its first thread, according to the first aspect, and a second connecting element, in particular its second thread, according to the first aspect.

Preferably, the changes in the first and second threads, particularly in the aforementioned variant c), add up to the second pitch (S_{diff}).

It is also advantageous, if at least part of the first thread, in particular the entire first thread, and at least part of the second thread, in particular the entire second thread, are engaged. There is a simple logical relationship here, because the more threads are in mutual engagement, the better the forces can be transmitted and stresses distributed.

It should be noted that preferably, when the two threads are screwed together, one thread forms the mating thread to the other. Thus, advantageously, the first thread is the mating thread to the second thread and vice versa.

Advantageously, the first thread is formed as an internal thread and the second thread is formed as an external thread, or the first thread is formed as an external thread and the second thread is formed as an internal thread.

Furthermore, it is advantageous if, for the internal thread, the first pitch (Sₙₒᵣₘ) is increased by the second pitch (S_{diff}), or if, for the external thread, the first pitch (Sₙₒᵣₘ) is decreased by the second pitch (S_{diff}).

It is also advantageous if, for the internal thread, the first pitch (Sₙₒᵣₘ) is increased by a proportion of the second pitch (S_{diff}) and, for the external thread, the first pitch (Sₙₒᵣₘ) is decreased by a proportion of the second pitch (S_{diff}).

Preferably, the proportions of the second pitch (S_{diff}) of the internal and external threads together result in the second pitch (S_{diff}).

In the case of a screw connection, both partners deform in the operating state;

namely the first connecting element and the second connecting element, which is screwed to the first connecting element.

Accordingly, it is advantageous if the second pitch (S_{diff}) is formed from the sum of the extension under strain (f_{first connecting element}) of the first connecting element or its connecting part and the extension under strain (f_{second connecting element}) of the second connecting element or its connecting part.

This is expressed in an equation as follows:

$${S}_{diff} = {f}_{first connecting element} + {f}_{second connecting element}$$

In light of the explanations concerning a connecting element according to the first aspect, which are preferably applicable herein, the following equations and the explanations made therewith under the first aspect may also be used.

$${S}_{diff} = f ( F ) / {n}_{g e s} or {S}_{diff} = f ( F ) / {n}_{teil}$$

$$f = δ * F$$

$$δ = {l}_{e} / ( E * {A}_{3} ) for external thread$$

$$δ = {l}_{e} / ( E * {A}_{N} ) for internal thread$$

For a screw connection with one internal and one external thread, the second pitch (S_{diff}) is preferably determined as follows:

$${S}_{diff} = [ {l}_{e} / ( E * {A}_{3} ) * F + {l}_{e} / ( E * {A}_{N} ) * F ] / {n}_{ges} or {n}_{teil}$$

Advantageously, the second pitch (S_{diff}) is variable by a factor (P) in a range between 100% and 550% or between 1 and 5.5. This is preferably expressed in an equation as follows:

S_{diff}*P; where P is variable between 1(100%) and 5.5(550%).

Also, it is favorable if at the factor (P) of 100%, all the threads turns (n_{ges}) screwed in during the operating state transmit forces.

Preferably, at a factor (P) of 550%, at least the three threads furthest away from the start of the thread in the operating state transmit forces.

Advantageously, the second pitch (S_{diff}) comprises an elastic and/or plastic extension under strain or compression of the tooth flanks of the threaded part screwed in during the operating state, on which the force acting in the operating state acts, so that the screwed-in threaded part has a modified length, in particular an increased or shortened length, compared to the unloaded state. In other words, the threaded connecting part of the connecting element also elongates due to the deformation of the threaded teeth or their tooth flanks.

If the first and second threads are now engaged, the tooth flanks of the first and second threads also advantageously deform in the operating state. As a result of the deformation or compression, e.g., tensile load on the connecting elements, the connecting parts of the two threads are consequently elongated. This means that the second pitch S_{diff} calculated above preferably changes by the sum of the compression or extension under strain (f_{Z, first connecting element}) of the first thread and the compression or extension under strain (f_{Z, second connecting element}) of the second thread.

This is preferably expressed in an equation as follows:

$${S}_{diff} = [ {l}_{e} / ( E * {A}_{3} ) * F + {l}_{e} / ( E * {A}_{N} ) * F ] / {n}_{ges or teil} + {f}_{Z , first connecting element} + {f}_{Z , second connecting element}$$

Preferably, in a screw connection along the length (lₑ) of the threaded part screwed in during the operating state, with which the connecting part can be screwed in or is screwed into a mating thread, the number of thread turns of one connecting part (n_{ges}), for example a screw nut, corresponds to the number of thread turns of the other screwed connecting part (nₜₑᵢₗ), for example a screw.

A third aspect comprises a method of producing a thread of a connecting part of a connecting element.

It is expressly noted that the features of the connecting element as mentioned in the first aspect may find application in the production method, both individually or in combination with one another.

Also, it is noted that the features of the screw connection as mentioned in the second aspect may be used individually or in combination with one another in the method of production.

In other words, the features mentioned above under the first aspect concerning the connecting element and also the features mentioned above under the second aspect concerning the screw connection may be combined here under the third aspect with additional features.

Preferably, the method comprises the following steps.

Advantageously, one step comprises determining a force acting in an operating state on a connecting element for connecting components, in particular on a connecting element with a known screw-in length (lₑ) or with the length of the threaded part screwed in during the operating state, with which the connecting part is screwed in a mating thread in an operating state. In other words, this determination involves determining the forces and/or stresses acting on a connecting element in an operating state (static or dynamic [threshold dynamic or alternating dynamic]). In other words, the acting loads are calculated for a specific load case (static or dynamic [threshold dynamic or alternating dynamic]) in order to be able to design the connecting part accordingly.

Furthermore, it is preferred that the number of thread turns screwed in during the operating state corresponds with the screw-in length (lₑ) or with the length of the threaded part screwed in during the operating state, with which the connecting part is screwed in or can be screwed in a mating thread. This means that preferably, for example, in the case of a screw connection of a screw with an internal thread, all thread turns (n_{ges}) of the internal thread and thus the length (lₑ) of the entire internal thread transmit forces. On the other hand, in the case of a screw, the part of the thread turns (nₜₑᵢₗ) that transmits forces is preferably the part that is screwed into or engaged with the internal thread in the operating state, and accordingly only the length (lₑ) of the screw thread that is screwed in during the operating state.

Preferably, the acting force (F) comprises an operating force (F_{B}), which preferably acts on the connecting element as an external tensile and/or compressive force.

Furthermore, it is possible for the acting force (F) to comprise an assembly pretensioning force (F_{M}), with which the connecting element preferably rests against a component in a fastening manner, in particular via an intermediate part.

Furthermore, it can be provided for that the acting force (F) comprises the operating force (F_{B}) and the assembly pretensioning force (F_{M}), which is preferably expressed in an equation as follows:

$$F = {F}_{B} + {F}_{M}$$

Furthermore, it is advantageous if one step comprises selecting a thread with a nominal diameter corresponding to the acting force. This means that based on the acting loads for a particular load case (static or dynamic [threshold dynamic or alternating dynamic]), the thread that is to transmit the expected loads is selected accordingly.

In addition, it is advantageous if one step of the method comprises determining the pitch (S_{ges}) of the thread. In this way, therefore, the thread to be created is defined.

Preferably, the pitch (S_{ges}) of the thread is made up of a first pitch (Sₙₒᵣₘ) and a second pitch (S_{diff}).

Preferably, the first pitch is a standard pitch (Sₙₒᵣₘ), in particular corresponding to the nominal diameter.

Furthermore, it may be provided that the second pitch (S_{diff}) corresponds to an amount of elastic and/or plastic extension under strain (f, f_{Z}) of the threaded connecting part occurring in the predetermined operating state of the connecting element.

Another preferred step of the method comprises a production of the thread. In this step, the selected thread is produced with its composite pitch made up of (Sₙₒᵣₘ) and (S_{diff}) or the first and second pitch.

Advantageously, the second pitch (S_{diff}) decreases or increases the first pitch (Sₙₒᵣₘ), in particular the standard pitch (Sₙₒᵣₘ), of the thread, which is preferably an internal or external thread.

Furthermore, it may be provided that the pitch (S_{ges}) of an internal thread is increased in case of a standard external thread:

$${S}_{g e s} = {S}_{norm} + {S}_{diff}$$

It is also favorable if the pitch of an external thread is decreased in case of a standard internal thread:

$${S}_{g e s} = {S}_{norm} - {S}_{diff}$$

Advantageously, the acting force (F) comprises an operating force (F_{B}), which preferably acts on the connecting element as an external tensile and/or compressive force.

It is also advantageous if the acting force (F) comprises an assembly pretensioning force (F_{M}), with which the connecting element preferably rests against a component in a fastening manner, in particular via an intermediate part.

Furthermore, it can be provided for that the acting force (F) comprises the operating force (F_{B}) and the assembly pretensioning force (F_{M}), which is preferably expressed in an equation as follows:

$$F = {F}_{B} + {F}_{M}$$

Advantageously, the production of the thread comprises a non-cutting process, in particular a cold extrusion process or a hot extrusion process, preferably forging on a forging press. Non-cutting processes include, for example, thread forming, thread milling, often also thread rolling, as well as other processes known to the person skilled in the art.

It is also advantageous if the production of the thread comprises a cutting process, in particular screw turning, screw milling, screw grinding, thread cutting or thread whirling.

The concept presented above will be further described in other words below.

This concept preferably relates, in simplified form, to a change of a thread of a connecting part of a connecting element or a change of the pitch of the thread, respectively, corresponding to the expected elongation or elastic and/or plastic extension under strain of the threaded connecting part, such as a screw shaft.

In this context, it is the object to avoid screw cracks.

This is achieved in the following manner:

preferably by reducing the tension in the notch root of the second thread turn, counted from the start of the thread at which screwing is started, while maintaining the tension force of the connection;

preferably by distributing the stresses over several threads of a screw connection starting from the depth or starting at the thread turns farthest from the start of the thread;

preferably by improving the fatigue strength of the screw, even in the case of overelastic tightening (yield strength controlled tightening);

preferably by compensating for screw elongation as a result of tensioning force or assembly pretensioning force and tensile load, and preferably for the deformations of the connection points (thread flanks).

When designing/calculating a screw connection, it has been noticed that preferably the compensation of the screw elongation or the extension under strain at tightening force (such as displacement of the core diameter of the screw) or at assembly pretensioning force over the screw-in depth leads to a distribution of stresses. However, this alone does not lead to sufficient stress distribution in the thread.

If, however, in addition to the screw elongation/extension under strain due to the tightening force/assembly pretensioning force, the additional extension due to the tensile and/or compressive loads or operating force acting on the screw and preferably additional setting effects or deformations in the thread flanks, or plasticizing from the overelastic tightening process (yield strength controlled tightening) are also taken into account, then the stress distribution can be further optimized.

The overelastic tightening method (yield strength controlled tightening) is advantageously used in part to achieve the most constant tightening force possible. Here, the screw is intentionally brought into a range above the yield strength (yield point), which significantly increases the extension of the screw (plasticizing being permitted).

It is therefore intended to change the pitch of the thread in such a way that any displacements of the connection in the area of the screw-in depth, which leads to extension under strain, is compensated for.

The total displacement in the screw-in depth range consists of the following components:

Displacement due to the standard tightening process (results in extension under strain due to the so-called assembly pretensioning force);

preferably displacement due to additional tensile and/or compressive loads (results in extension under strain or shortening due to an acting operating force);

preferably displacement of the tooth flanks in the connection (results in extension under strain due to the so-called assembly pretensioning force and/or an acting operating force);

preferably plasticizing, such as by the overelastic tightening process (yield strength controlled tightening) (results in extension under strain due to the so-called assembly pretensioning force and/or an acting operating force in a plastic range).

In simplified terms, the total displacement or total extension under strain in the area of the screw-in length can be determined as follows:

The factor (P) 100% to max. 550% preferably takes into account the displacement over the screw-in length (lₑ) in the core diameter of the screw according to standard tightening procedures up to the area with plastic deformation and preferably after the acting operating force.

As already mentioned, the connecting element with a thread modified according to the extension under strain behaves contrary to a connecting part with a standard thread. This is because in the case of standard threads, almost exclusively the first three thread turns (counted from the start of the thread at which the screw connection is started) transmit forces. In contrast, in the case of the connecting element with a modified thread, either all the thread turns (n_{ges}) screwed in during the operating state transmit forces (this is preferably the case at P=100%) or at least the three thread turns furthest away from the start of the thread in the operating state (counted from the start of the thread at the screw connection is started) (this is preferably the case at P=550%).

In a normal case, the displacement of the core diameter in the standard tightening process is preferably between 2 μm and 12 μm per millimeter of screw-in length. This depends on the strength of the screw or the elastic modulus of the screw and the pretensioning force recommended in that case.

The thread pitch must therefore be designed as follows:

Screw-in length: lₑ

Screw extension in the area of the screw-in depth at standard tightening torque: lₛ

Elastic modulus: E

Tensile load due to the standard tightening process on the screw: F_{z}

Number of thread turns, in particular the screwed in thread turns transmitting the forces: n

Pitch difference from external thread to internal thread, wherein the internal thread preferably has the greater pitch: S_{diff}

$${l}_{s} = {1}_{e} / ( E * A ) * {F}_{z} ;$$

$${S}_{diff} = ( {l}_{s} / n ) * 1 to ( {l}_{s} / n ) * 5.5 ;$$

where 1 and 5.5 correspond to the above factor (P);

The pitch of the internal thread for a standard external thread would therefore be:

$${S}_{g e s} = {S}_{norm} + {S}_{diff}$$

The pitch of the external thread for a standard internal thread, on the other hand, would be:

$${S}_{g e s} = {S}_{norm} - {S}_{diff}$$

Of course, both threads (internal and external) can also deviate from the standard and together exhibit the pitch difference (S_{diff}) mentioned above.

To enable thread partners with different pitches to be screwed in, it is also preferable to increase the clearance (x) between the teeth in the internal thread and/or in the external thread or the distance (x) between two tooth flanks of two adjacent teeth of the thread.

The amount (z) by which the clearance (x) or distance (x) is increased should preferably be in the range of z=S_{diff}*(n+1).

Thus, if a displacement of the core diameter of 2 μm per millimeter is expected for a standard pitch (Sₙₒᵣₘ) of 1.5 mm and a screw-in length (lₑ) of 10 mm, the pitch difference (S_{diff}) should preferably be designed as follows:

The extension under strain (f) results from the displacement (δ) of the core diameter after standard tightening to 10 mm insertion length (lₑ):

$$2 μm / mm * 10 mm = 20 μm$$

Number of thread turns (nₜₑᵢₗ) in engagement: 10 mm/1.5 mm=6.66666

Second pitch or pitch difference S_{diff}: (20 μm/6.66666)*1=3 μm, where 1 corresponds to the factor P

Optimum tooth space (x) or distance (x) between two tooth flanks of two adjacent teeth of the thread larger than the tooth by about 3 μm×(6.66666+1)=23 μm.

Pitch difference S_{diff}: (20 μm/6.66666)*5.5=16.5 μm, where 5.5 corresponds to the factor P

Optimum tooth space (x) or distance (x) between two tooth flanks of two adjacent teeth of the thread larger than the tooth by about 16.5 μm×(6.66666+1)=126.5 μm.

Or

If a displacement (δ) of the core diameter of 12 μm per millimeter is expected for a standard pitch (Sₙₒᵣₘ) of 1.5 mm and a screw-in length (lₑ) of 10 mm, the pitch difference (S_{diff}) should preferably be designed as follows:

The extension under strain (f) results from the displacement (δ) of the core diameter after standard tightening to 10 mm insertion length (lₑ):

$$12 µm / mm * 10 = 120 µm$$

Number of thread turns (nₜₑᵢₗ) in engagement: 10 mm/1.5 mm=6.66666

Pitch difference S_{diff}: (120 μm/6.66666)*1=18 μm, where 1 corresponds to the factor P

Optimum tooth space (x) or distance (x) between two tooth flanks of two adjacent teeth of the thread larger than the tooth by about 18 μm×(6.66666+1)=138 μm.

Pitch difference S_{diff}: (120 μm/6.66666)*5.5=99 μm, where 5.5 corresponds to the factor P

Optimum tooth space (x) or distance (x) between two tooth flanks of two adjacent teeth of the thread larger than the tooth by about 99 μm×(6.66666+1)=759 μm.

The tooth space can also only be at least as large as the size of the teeth of the mating thread, but the screw is then difficult to screw in due to the immediate tensioning.

A larger tooth space, on the other hand, is favorably not disadvantageous for the screwing torque to be applied when screwing in, but is even, in particular over the known screw-in length (lₑ) or over the length (lₑ) of the threaded part screwed in during the operating state, with which the connecting part is screwed in or can be screwed in a mating thread, much easier to operate, but preferably leads to a decrease in the supporting force of the teeth.

Due to this improvement, the stresses in the thread are preferably first built up from the deeper screw-in point and then distributed bit by bit (depending on the design and the tensioning force or assembly pretensioning force) to the other thread turns. It would also be possible, for example, that only the deepest three screwed-in thread turns bear loads. Thus, the less deeply screwed-in area (non-load-bearing area) preferably would serve as an extension area, but can take over forces in the event of further loading or also maintain the connection in the event of possible tearing or through possible setting at the deeper thread turns and thus serves as a securing area.

In general, the less deep thread turns or the thread turns at the start of the thread are subjected to significantly lower loads, thus avoiding screw cracks in the critical area.

In this way, downsizing is also possible, since a screw connection can withstand significantly higher loads than conventional threads.

The thread combination is preferably applicable to all screw connections, especially those where the screw-in length is known.

The new thread design can be used, for example, in the automotive and industrial sectors, as well as for all other screw connections.

The screw connections can consist of metallic (steel, aluminum) or non-metallic (plastics) connecting partners.

The principle of different pitches is preferably applicable to all possible threads.

### BRIEF DESCRIPTION OF THE DRAWINGS

The connection method is explained in more detail below with reference to examples of embodiments in conjunction with associated drawings. The figures schematically show the following:

FIG. 1 shows a sectional view of a screw connection for connecting components;

FIG. 2 shows an enlarged sectional view of the screw connection from FIG. 1;

FIG. 3 shows an enlarged view from FIG. 2;

FIG. 4 shows a diagram of an FEM analysis of a screw in a modified internal thread;

FIG. 5 shows an enlarged view from FIG. 4;

FIG. 6 shows a view similar to FIG. 5, but for a screw in a standard internal thread;

FIG. 7 shows a sectional view, similar to FIG. 1;

FIG. 8 shows a diagram for the strain progression along the thread turns; and

FIG. 9 shows a diagram of the stress curve along the thread turns.

### DETAILED DESCRIPTION

In the description below, the same reference signs will be used for the same components.

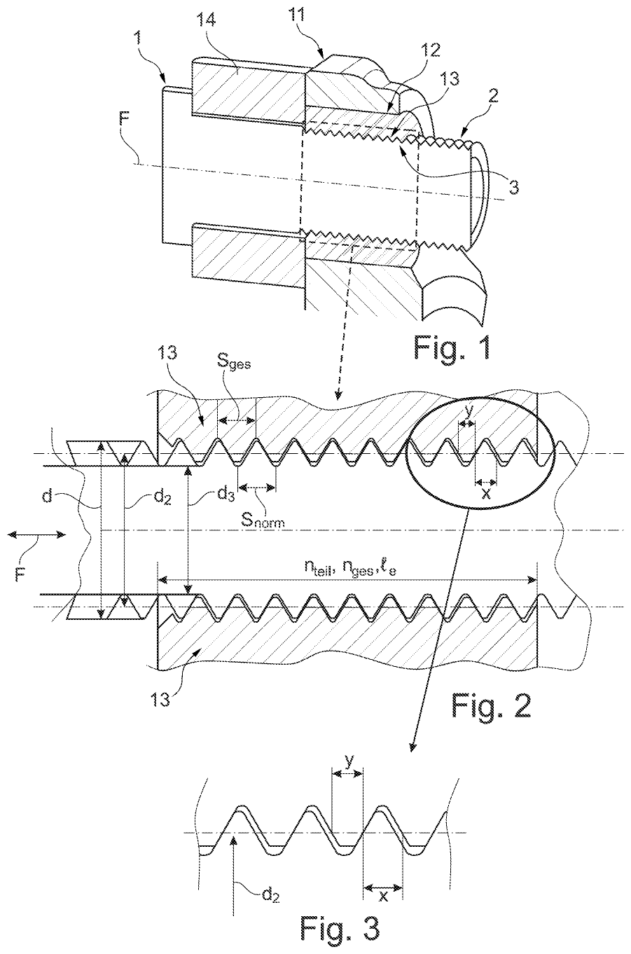

FIG. 1 shows a sectional view of a screw connection for connecting components.

More precisely, FIG. 1 shows a screw connection with a first connecting element 1 and a second connecting element 11.

Here, the first connecting element 1 has a first thread 3 and the second connecting element 11 has a second thread 13, wherein at least a portion of the first thread 3 and all of the second thread 13 are engaged.

The first thread 3 is designed as an external thread and the second thread 13 is designed as an internal thread, wherein the connecting element 1 is designed as a screw and the connecting element 11 is designed as a wheel flange.

In the present case, the internal thread has a first pitch Sₙₒᵣₘ, which corresponds to the standard pitch for this thread, increased by a second pitch S_{diff}.

FIG. 2 shows an enlarged sectional view of the screw connection from FIG. 1.

The connecting element 11 with internal thread is described in more detail below, although the statements made there are also applicable to, for example, a screw with an external thread.

According to FIG. 1, the connecting element 11 has a connecting part 12, which has a thread 13.

The thread 13 has a nominal diameter d, a flank diameter d₂, a pitch S_{ges}, and thread turns n_{ges}.

The pitch S_{ges} of the thread 13 is made up of a first pitch Sₙₒᵣₘ and a second pitch S_{diff}, wherein the first pitch is a standard pitch Sₙₒᵣₘ, in particular corresponding to the nominal diameter d.

In other words, this means:

$${S}_{g e s} = {S}_{norm} + {S}_{diff}$$

The second pitch S_{diff}, on the other hand, corresponds to an amount of elastic and/or plastic extension under strain f, f_{Z} of the threaded connecting part 12, wherein the extension under strain f, f_{z} occurs in a predetermined operating state of the threaded connecting element 11.

In this predetermined operating state, the threaded connecting part 12 is designed for an acting force F.

The acting force F comprises an operating force F_{B}, which acts on the connecting element 11 as an externally acting tensile and/or compressive force, and an assembly pretensioning force F_{M}, with which the connecting element 11 is fastened to a component or to the connecting element 1 via an intermediate part 14 (F=F_{B}+F_{M}).

Due to the action of the axially extending, acting force F, the elastic and/or plastic extension under strain f, f_{Z} runs in the direction of extension of the thread 13.

As mentioned above, the second pitch S_{diff} increases the first pitch Sₙₒᵣₘ of the thread 13, wherein the first pitch Sₙₒᵣₘ has a metric standard, in particular a metric thread, corresponding to the nominal diameter d.

To be precise, the second pitch S_{diff} has a quotient that has a dividend and a divisor.

The dividend comprises the elastic and/or plastic extension under strain f of the threaded connecting part 12 at the force F acting in the operating state, and the divisor comprises all the thread turns n_{ges} of the thread 13 that are screwed in during the operating state.

This is expressed in an equation as follows:

$${S}_{diff} = f ( F ) / {n}_{g e s}$$

Furthermore, the elastic and/or plastic extension under strain f comprises a product composed of the displacement δ of the thread core and the force F acting in the operating state (f=δ*F).

Furthermore, the displacement δ of the thread core has a quotient that has a dividend and a divisor.

The dividend comprises the length lₑ of the threaded part screwed in during the operating state, with which the connecting part 12 is screwed in a mating thread 3.

The divisor comprises a product of the elastic modulus E of the material of the connecting element 12 and the cross-section of the thread 13, wherein the cross-section of the thread 13 corresponds to the nominal cross-section A_{N} for an internal thread.

These statements can be expressed in an equation as follows:

$$δ = {l}_{e} / ( E * {A}_{N} )$$

In order to now have all thread flanks of the connecting part 12 rest against the connecting part 2 of the connecting element 1, the second pitch S_{diff} can be varied with a factor P in a range between 100% and 550% or between 1 and 5.5, wherein in the present case with the factor P of 100% all thread turns n_{ges} screwed in during the operating state transmit forces.

If the factor P were equal to 550%, at least the three thread turns farthest from the thread start in the operating state would transmit forces.

The above statements offset with numbers lead, for example, to the following interpretation of the pitch S_{ges}.

$${S}_{g e s} = {S}_{norm} + {S}_{diff} \\ {S}_{diff} = f ( F ) / {n}_{g e s} = δ * F / {n}_{g e s} = {l}_{e} / ( E * {A}_{N} ) * F / {n}_{g e s}$$

Preferably, the number of all thread turns n_{ges} of the thread is reduced by a factor of 1 in case of an internal thread. This means, preferably:

$${n}_{ges , internal thread} = {n}_{ges} - 1 or {n}_{teil , internal thread} = {n}_{teil} - 1$$

With this improvement, an even better stress distribution can be achieved. For simplicity and clarity, this preferred improvement is omitted below.

Thus, if a displacement of the core diameter of 2 μm per millimeter is expected for a standard pitch Sₙₒᵣₘ of 1.5 mm for an M8 thread and a screw-in length lₑ of 10 mm, the pitch difference S_{diff} should preferably be designed as follows:

Displacement δ of the core diameter of an M8 thread (taken from table) after standard tightening to 10 mm screw-in length lₑ for example:

$$2 µm / mm * 10 = 20 µm Number of thread turns ( {n}_{g e s} ) in engagement : 10 mm / 1.5 mm = 6.66666 Pitch difference {S}_{diff} \text{:} ( 20 µm / 6.66666 ) * 1 = 3 µm$$

To enable thread partners with different pitches to be screwed in, it is also preferable to increase the clearance x between the teeth in the internal thread and/or in the external thread or the distance x between two tooth flanks of two adjacent teeth of the thread.

The amount z by which the clearance x or the distance x is increased should be in the range of z=S_{diff}*(n+1).

Optimum tooth space x or distance x between two tooth flanks of two adjacent teeth of the thread by about 3 μm×7.66666=23 μm larger than the tooth.

FIG. 3 shows an enlarged view from FIG. 2, wherein the following explanations apply to FIGS. 2 and 3.

In addition to the changed pitch S_{ges} (S_{ges}=Sₙₒᵣₘ+S_{diff}), the connecting element 11 has a distance x between two tooth flanks of two adjacent teeth of the thread 13 along the flank diameter d₂, which is changed by an amount z.

Here, the distance x corresponds to the corresponding distance resulting from the first pitch Sₙₒᵣₘ.

In the present example, the distance x between the two opposing tooth flanks of two adjacent teeth is increased along the flank diameter d₂ by the amount z, wherein the amount z corresponds to the product of the second pitch S_{diff} and the sum of the thread turns n_{ges} of the thread screwed in during the operating state or their number and 1. As already indicated above, this is expressed in an equation as follows:

$$z = {S}_{diff} * ( {n}_{g e s} + 1 )$$

This makes it easy to screw the threaded connecting part 12 into a mating thread 3 or into a connecting part 2 having a mating thread. Also, with this embodiment, it can be ensured that the thread turns furthest from the start of the thread transmit forces and not the thread turns located at the start of the thread 12, as is usual with a standard thread.

In other words, each distance x between two opposing tooth flanks of two adjacent teeth is increased along the flank diameter d₂ by the amount z, thus increasing the clearance x or distance x between the teeth or thread teeth.

From a different perspective, the width y of each tooth of the thread 13 or the distance y between two tooth flanks of a thread tooth of the thread 13 is changed by an amount z along the flank diameter d₂.

Here, the distance y corresponds to the corresponding distance resulting from the first pitch Sₙₒᵣₘ.

To be precise, the distance y between two tooth flanks of a thread tooth of the thread 13 along the flank diameter d₂ is decreased by an amount z which corresponds to the product of the second pitch S_{diff} and the sum of the thread turns n_{ges}, nₜₑᵢₗ of the thread screwed in during the operating state or their number and 1.

As a result, the distance y is expressed in an equation as follows:

$$y = {S}_{diff} * ( {n}_{g e s} + 1 )$$

Regardless of whether the distance x or the distance y is considered, the tooth flank angle of the thread 13 remains unchanged and corresponds to the tooth flank angle of the first pitch Sₙₒᵣₘ.

Furthermore, the second pitch S_{diff} comprises an elastic and/or plastic extension under strain or compression f_{Z} of the tooth flanks of the threaded part 13 screwed in during the operating state, on which the force F acting in the operating state acts. Thus, the screwed-in threaded part 13 has a changed length compared to the unloaded state, in particular an increased length under a tensile load. In other words, the threaded connecting part of the connecting element also elongates due to the deformation of the threaded teeth or their tooth flanks or the connecting part does not elongate due to the extension under strain of the tooth flanks, because the tooth flanks compensate for the extension by deformation.

Here, the second pitch S_{diff} corresponds to a quotient that has a dividend and a divisor

The dividend comprises the elastic and/or plastic extension under strain or compression f_{Z} of the tooth flanks of the threaded part screwed in during the operating state when a force F is acting on the connecting part 12.

The divisor has all the thread turns n_{ges} of the thread 13, which are the number of thread turns screwed in during the operating state.

This is preferably expressed in an equation as follows:

$${S}_{diff} = {f}_{Z} ( F ) / {n}_{g e s}$$

In a screw connection, as shown in FIG. 1, both partners deform in the operating state; namely the first connecting element 1 and the second connecting element 11, which is screwed to the first connecting element 1.

Accordingly, it is advantageous if the second pitch (S_{diff}) is formed from the sum of the extension under strain f_{first connecting element} of the first connecting element 1 or its connecting part 2 and the extension under strain f_{second connecting element} of the second connecting element 11 or its connecting part 12.

This is expressed in an equation as follows:

$${S}_{diff} = {f}_{first connecting element} + {f}_{second connecting element}$$

In light of the explanations concerning the connecting element 11 above, which are applicable here to the first connecting element 1, the following equations and the explanations made therewith under the first aspect may also be used.

$${S}_{diff} = f ( F ) / {n}_{g e s} or {S}_{diff} = f ( F ) / {n}_{teil}$$

$$f = δ * F$$

$$δ = {l}_{e} / ( E * {A}_{3} ) for an external thread or$$

$$δ = {l}_{e} / ( E * {A}_{N} ) for an internal thread$$

For a screw connection with one internal and one external thread, the second pitch (S_{diff}) is preferably determined as follows:

$${S}_{diff} = [ {l}_{e} / ( E * {A}_{3} ) * F + {l}_{e} / ( E * {A}_{N} ) * F ] / {n}_{g e s}$$

Since the first and second connecting elements 1, 11 are screwed together over the same length lₑ and thus have the same number of thread turns engaged with each other, n_{ges} is therefore equal to nₜₑᵢₗ or n_{ges}=nₜₑᵢₗ.

Advantageously, the second pitch S_{diff} is variable by a factor P in a range between 100% and 550% or between 1 and 5.5, as shown above. This is expressed in an equation as follows:

S_{diff}*P; where P is variable between 1(100%) and 5.5(550%).

In summary, the pitch S_{ges} of the thread is advantageously made up of the first pitch Sₙₒᵣₘ and the second pitch S_{diff} with the factor P. This is preferably expressed in an equation as follows:

$${S}_{g e s} = {S}_{norm} + P * {S}_{diff}$$

Furthermore, the second pitch S_{diff} comprises an elastic and/or plastic extension under strain or compression f_{Z} of the tooth flanks of the threaded part 3, 13 screwed in during the operating state, on which the force F acting in the operating state acts, so that the screwed-in threaded part has a changed length, in particular an increased or shortened length, compared to the unloaded state.

In other words, the connecting part 2, 12 having a thread 3, 13 of the connecting element 1, 11 also elongates due to the deformation of the threaded teeth or their tooth flanks.

If the first and second threads 3, 13 are now engaged, as in FIGS. 1 and 2, both threads and their tooth flanks deform in the operating state and thus under the action of an assembly pretensioning force and an operating force.

The extension under strain of the threaded connecting parts 2, 12 and the compression of the tooth flanks, such as under tensile load on the connecting elements 1, 11, consequently elongate the connecting parts 2, 12 of the two threads 3, 13.

This means that the second pitch S_{diff} changes by the sum of the compression or extension under strain f_{Z, first connecting element} of the first thread and the compression or extension under strain f_{Z, second thread} of the second thread.

This is preferably expressed in an equation as follows:

$${S}_{diff} = [ {l}_{e} / ( E * {A}_{3} ) * F + {l}_{e} / ( E * {A}_{N} ) * F ] / {n}_{ges} + {f}_{Z , first connecting element} + {f}_{Z , second connecting element}$$

A method for producing the thread 13 of the connecting part 12 of the connecting element 11 comprises the following steps:

Determining an acting force F on the connecting element 11 for connecting components in an operating state,

selecting a thread 13 with a nominal diameter d corresponding to the acting force F,

Determining the pitch S_{ges} of the thread 13, wherein the pitch S_{ges} of the thread 3, 13 is made up of a first pitch Sₙₒᵣₘ and a second pitch S_{diff}.

Here, the first pitch is a standard pitch Sₙₒᵣₘ, in particular corresponding to the nominal diameter d, and the second pitch S_{diff} is an elastic and/or plastic extension under strain f, f_{Z} of the threaded connecting part 12 occurring in the predetermined operating state of the connecting element 11.

Finally, the thread 13 is produced.

Production is possible by means of a non-cutting process, in particular a cold extrusion process or a hot extrusion process, preferably forging on a forging press.

It is also possible that the production of the thread 13 comprises a machining process, in particular screw turning, screw milling, screw grinding or thread whirling.

To illustrate the effects of the changes to the thread 13, the following figures show the following:

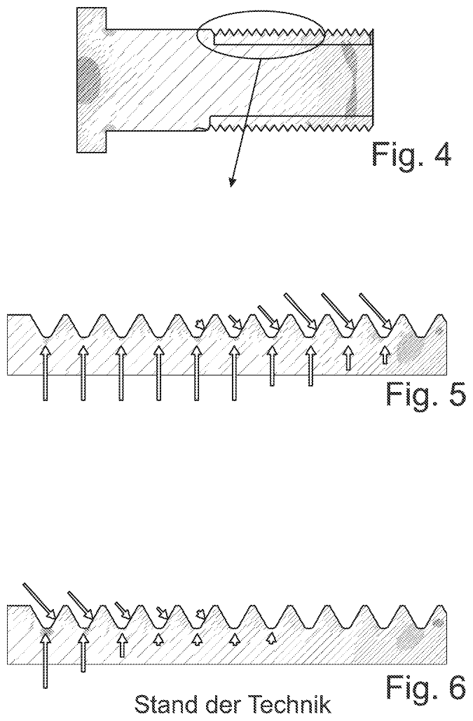

FIG. 4 shows a diagram of an FEM analysis of a screw in an internal thread modified, as previously described;

FIG. 5 shows an enlarged view from FIG. 4;

FIG. 6 shows a view similar to FIG. 5, but for a screw in a standard internal thread;

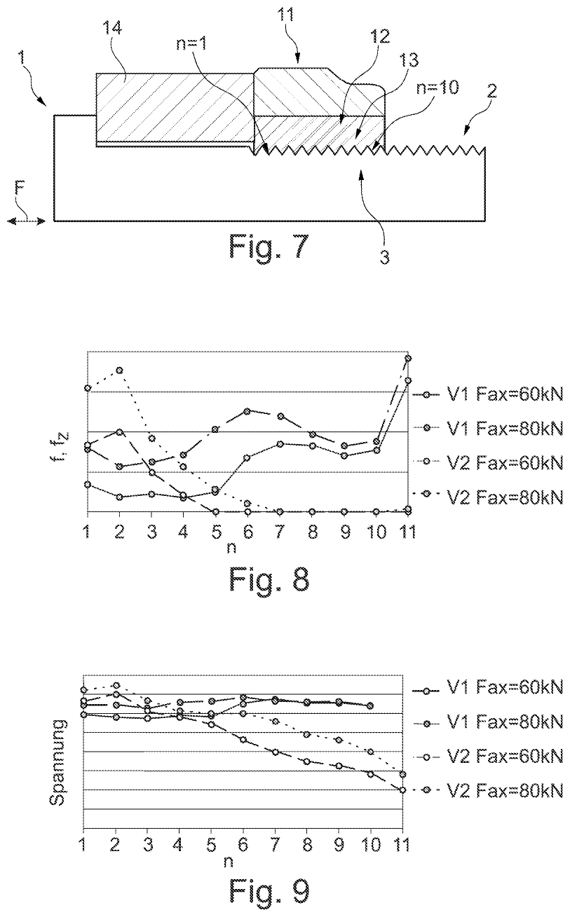

FIG. 7 shows a sectional view, similar to FIG. 1;

FIG. 8 shows a diagram of the strain progression along the thread turns; and

FIG. 9 shows a diagram of the stress curve along the thread turns.

FIG. 5 shows that the external thread of screw 3 is subjected to stresses uniformly along the length of the screw due to the modified internal thread (not shown).

Here, the arrows below the screw illustrate the stress occurring at the corresponding location.

The arrows above the screw, on the other hand, illustrate the contact stress or surface pressure between the thread teeth of the internal thread (not shown) and the external thread of the screw.

In comparison, FIG. 6 shows the loads on an external thread of a screw that is screwed into an internal standard thread.

It is immediately apparent from the arrows below the screw that the loads or stresses that occur are greatest in the first thread turns and then decrease significantly thereafter.

The arrows above the screw, on the other hand, illustrate the contact stress or surface pressure between the thread teeth of the internal thread (not shown) and the external thread of the screw.

The aforementioned stresses or loads shown in FIG. 6 cause the screws to tear off at the first thread turns.

In contrast, as mentioned, the screw according to FIG. 5 is stressed or loaded much more uniformly starting from the depth or at the thread turns furthest away from the start of the thread and over the length lₑ of the threaded part screwed in during the operating state, with which the connecting part is screwed into the internal thread.

Whereas in the screw shown in FIG. 6 the frontmost thread turns at the start of the thread (on the left in FIGS. 4 to 6) are subjected to the greatest contact stress to the internal thread (not shown), the situation is different in the connecting element, as shown in FIG. 5.

Here, the thread turns furthest away from the start of the thread (on the right in FIGS. 4 to 6) are stressed with the greatest contact stress to the internal thread (not shown), resulting in a distribution of the occurring stresses to several thread turns of a screw connection starting from the depth or starting at the thread turns furthest away from the start of the thread. The front thread turns are only loaded with the tensile stress but not with the contact stress or surface pressure of the respective tooth flank.

FIGS. 7 to 9 show the above statements clearly in the form of a diagram.

While FIG. 7 again shows the screw connection from FIG. 1 with the first and tenth thread turns of the external thread of the connecting element 11, FIGS. 8 and 9 show the strains and stresses in the thread turns of the screw.

It is again emphasized that the screw or its thread has an unchanged pitch or a standard pitch.

On the other hand, the internal thread of the connecting element 11 is modified.

Since the screw is screwed into the internal thread, the following statements regarding the external thread of the screw or the screw apply analogously to the internal thread, which deforms identically to the screw, since they are in engagement with one another.

Thus, in FIG. 8, for each individual thread turn and for two different loads (60 kN and 80 kN), the elastic and/or plastic extension under strain of the screw manufactured according to a standard and screwed into a modified internal thread is shown.

FIG. 8 shows that the version V1, which is a standard screw in a modified internal thread, stretches more uniformly along the thread turns than a standard screw in a standard internal thread (V2).

FIG. 9 shows, for each thread turn and for two different loads (60 kN and 80 kN), the stress of the screw produced according to a standard and screwed into a modified internal thread.

FIG. 9 shows that version V2, which is a standard screw in a standardized internal thread, is unevenly loaded along the thread turns. On the other hand, the standard screw in the modified internal thread is more evenly loaded with stresses along the thread turns (V1).

### LIST OF REFERENCE SYMBOLS

1 Connecting element
2 Connecting part
3 Thread
11 Connecting element
12 Connecting part
13 Thread
14 Intermediate part
d Nominal diameter
d₂ Flank diameter
A₃ Core cross-section
A_{N} Nominal cross-section
S_{ges} Pitch
Sₙₒᵣₘ First pitch
S_{diff} Second pitch
n_{ges} Thread turns
nₜₑᵢₗ Thread turns
f, f_{Z} Extension under strain
F Force
F_{M} Assembly pretensioning force
F_{B} Operating force
P Factor
δ Displacement
E Elastic modulus
x Distance between two tooth flanks of two adjacent teeth of the thread along the flank diameter
y Distance between two tooth flanks of a thread tooth of the thread along the flank diameter
z Amount by which the distance x or y is changed
lₑ Screw-in length or length of the threaded part screwed in during the operating state, with which the connecting part is screwed in a mating thread

1. A connecting element having a connecting part, which has a thread,
wherein the thread has a nominal diameter,
a flank diameter,
a pitch, and
a number of thread turns,
wherein the pitch of the thread is made up of a first pitch and a second pitch,
wherein the first pitch is a standard pitch corresponding to the nominal diameter, and
wherein the second pitch corresponds to an amount of elastic or plastic extension under strain of the threaded connecting part,
wherein the extension under strain occurs in a predetermined operating state of the threaded connecting element.

2. The connecting element according to claim 1,
wherein the elastic or plastic extension under strain runs in the direction of extension of the thread due to the action of the axially extending, acting force,
wherein in the predetermined operating state the threaded connecting part is designed for an acting force,
wherein the acting force comprises an operating force, which acts on the connecting element as an external tensile or compressive force,
wherein the acting force comprises an assembly pretensioning force, with which the connecting element rests against a component in a fastening manner via an intermediate part,
wherein the second pitch is less than or greater than the first pitch of the thread,
wherein the first pitch corresponds to the nominal diameter according to a metric standard or an inch standard.

3. The connecting element according to claim 1,
wherein the second pitch has a quotient having a dividend and a divisor,
wherein the dividend comprises the elastic or plastic extension under strain of the threaded connecting part at the force acting in the operating state and the divisor comprises the number of thread turns screwed in during the operating state,
wherein the second pitch is variable by a factor in a range between 100% and 550%,
wherein at a factor of 100%, all thread turns screwed in during the operating state transmit forces,
wherein at a factor of 550%, at least a three thread turns furthest from the start of the thread during the operating state transmit forces.

4. The connecting element according to claim 1,
wherein the second pitch comprises a product composed of a displacement of the thread core and the force acting in the operating state,
wherein the displacement of the thread core comprises a quotient having a dividend and a divisor,
wherein the dividend comprises the length of the threaded part screwed in during the operating state, with which the connecting part is screwed in a mating thread,
wherein the divisor comprises a product of the elastic modulus of the material of the connecting element and the cross-section of the thread,
wherein the cross-section of the thread corresponds to the core cross-section for an external thread or to the nominal cross-section for an internal thread.

5. The connecting element according to claim 1,
wherein a distance between two tooth flanks of two adjacent teeth of the thread along the flank diameter or a distance between two tooth flanks of a thread tooth of the thread along the flank diameter is varied by an amount,
wherein the distance corresponds to the corresponding distance resulting from the first pitch,
wherein preferably the distance changed by an amount along the flank diameter,
wherein the amount corresponds to a product of the second pitch and a sum of the number of thread turns and 1,
wherein the number of thread turns is the number of thread turns screwed in during the operating state,
wherein the tooth flank angle of the thread remains unchanged and in particular corresponds to the tooth flank angle of the first pitch.

6. The connecting element according to claim 1,
wherein the second pitch comprises an elastic or plastic extension under strain of the tooth flanks of the threaded part screwed in during the operating state, on which the force acting in the operating state acts, so that the screwed-in threaded part has a changed length, in particular an increased or shortened length, compared to the unloaded state,
wherein the second pitch has a quotient comprising a dividend and a divisor,
wherein the dividend comprises the elastic or plastic extension under strain of the tooth flanks of the threaded part screwed in during the operating state when a force is acting on the connecting part,
wherein the divisor comprises the number of thread turns screwed in during the operating state.

7. A screw connection for the connection of components, comprising:
a first connecting element according to claim 1, and
a second connecting element according to claim 1,
wherein the first connecting element comprises a first thread and the second connecting element comprises a second thread,
wherein the first thread and the second thread are engaged.

8. The screw connection according to claim 13,
wherein, for the internal thread, the first pitch is increased by a proportion of the second pitch and, for the external thread, the first pitch is decreased by a proportion of the second pitch, and
wherein the proportions of the second pitch of the internal and external threads together result in the second pitch.

9. A method for producing a thread of a connecting part of a connecting element comprising:
determining an acting force on a connecting element for connecting components in an operating state,
selecting a thread with a nominal diameter corresponding to the acting force,
determining the pitch of the thread,
wherein the pitch of the thread is made up of a first pitch and a second pitch,
wherein the first pitch is a standard pitch corresponding to the nominal diameter, and
wherein the second pitch corresponds to an amount of elastic or plastic extension under strain of the threaded connecting part occurring in the predetermined operating state of the connecting element, and
producing the thread.

10. The method according to claim 9,
wherein the second pitch is less than or greater than the first pitch of the thread,
wherein the acting force comprises an operating force, which acts on the connecting element as an external tensile or compressive force,
wherein the acting force comprises an assembly pretensioning force, with which the connecting element rests against a component in a fastening manner via an intermediate part.

11. The connecting element according to claim 2, wherein the connecting element with the connecting part having a thread is a component with an external thread.

12. The connecting element according to claim 2, wherein the connecting element connecting part with the connecting part having a thread is a component with an internal thread.

13. The screw connection of claim 7, wherein the first thread is formed as an internal thread and the second thread is formed as an external thread.

14. The screw connection of claim 7, wherein the first thread is formed as an external thread and the second thread is formed as an internal thread.

15. The screw connection according to claim 14,
wherein, for the internal thread, the first pitch is increased by a proportion of the second pitch and, for the external thread, the first pitch is decreased by a proportion of the second pitch, and
wherein the proportions of the second pitch of the internal and external threads together result in the second pitch.

16. The method of claim 10 wherein the production of the thread comprises a non-cutting process.

17. The method of claim 10 wherein the production of the thread comprises a machining process.
